(19) United States
(12) Patent Application Publication
(10) Pub. No.: US 2012/0303174 A1
(43) Pub. Date: Nov. 29, 2012

(54) Green Data Center and the Method for Achieving Power Usage Efficiency less than 1

(75) Inventors: Oliver SZU, Taipei (TW); Stone TSENG, Taipei (TW)

(73) Assignee: GCCA INC., Tortola (BV)

(21) Appl. No.: 13/291,316

(22) Filed: Nov. 8, 2011

(30) Foreign Application Priority Data
May 27, 2011 (TW) 100118762

(51) Int. Cl. G06F 1/26

(52) U.S. Cl. 700/297; 713/320

(57) ABSTRACT

A green data center is provided, which comprises: a utility power source for providing utility power; a facility electrically connected to the utility power source; a renewable energy provider electrically connected to the facility for providing renewable energy; an IT equipment electrically connected to the renewable energy provider; wherein the total power received by the IT equipment is not less to the utility power provided by the utility power source, so that the PUE (Power Usage Efficiency) can be less than one, thereby achieving the effect of carbon-reducing and energy-saving.

### FIELD OF THE INVENTION

The present invention generally relates to a green data center, in particular, to a green data center and the operating method capable of achieving PUE (power usage efficiency) less than 1.

### DESCRIPTION OF THE PRIOR ART

In pace with the development of technology, the flourish of the network recently breeds many websites to attract members up to millions or even more, such as: Google, Facebook, Yahoo, Youtube, Twitter, Myspace, and so on. These well-known websites, benefited from the trend of the network, are browsed by members from the whole world in every single minute. However, it may seriously burden the servers or data centers of these websites. Therefore, a great amount of power must be required for the data center, so as to prevent the failure of the website.

Generally speaking, a conventional data center comprises basic facilities and IT devices, wherein the basic facilities, including the illuminating facility, the UPS, the air conditioner, or other non-IT devices, are used to maintain the operation of the data center. The IT devices, used to store, process, compute, or transfer data of the website, are the main cores of the data center, and it may comprise a server, a storage device, a network device, or a telecommunication device.

FIG. 1 shows a conventional data center and the power system. As shown in the figure, the utility power can be transmitted to the basic facility 103 in the data center by the utility power source 101, and part of the utility power can be consumed by the basic facility 103 for enabling the operation. In this case, the basic facility 103 may include an illuminating facility 103a, a UPS 103b, an air conditioner 103c, or other non-IT devices or any combinations of aforementioned devices. Further, the utility power can be measured by the utility power meter 102 before it is transmitted into the basic facility 103. Subsequently, the residual of utility power can be transmitted to the IT device 105 for facilitating the computing. The data center 100 further includes an IT power meter 104 electrically connected between the IT device 105 and the basic facility 103 for measuring the power transmitting to the IT device 105. In this case, the IT device 105 also includes a server 105a, a network device 105b, or a storage device 105c as mentioned above.

Based on aforementioned description, it can be acknowledged that the utility power A provided by the utility power source 101 equals the summation of the power B acquired by the basic facility 103 and the power C acquired by the IT device 105, namely, A=B+C. In order to monitor the energy consumption of the data center, PUE (power usage efficiency), which equals A/C (the utility power A divided by the power C acquired by the IT device 105), is introduced in the related art for acting as an index of the energy efficiency. Because the basic facility 103 may consume the power B, the power C received by the IT device 105 must be less than the utility power A provided by the utility power source 101. In other words, PUE must be greater than 1. The lower PUE is, the higher the efficiency will be, thereby achieving the purpose of saving power consumption.

According to statistics, the power consumed by data centers approximates 1.5% of the total power consumption of U.S.A in recent years. For those companies of websites, the power cost is quite considerable. Therefore, those companies make many efforts to improve the PUE. For example, the data center can be built at the high-latitude or high altitude area for omitting the air conditioners due to the naturally low-temperature environment, so that the power B required by the basic facility 103 can be decreased, thereby making PUE closer to 1. In other cases, specially-designed fans can be employed to dissipate heat, thereby reducing needs for air conditioners. By aforementioned methods, those top websites, such as Google and Facebook, can effectively reduce PUE down to about 1.1, so as to decrease the energy consumption.

However, the power and the energy has become more and more precious nowadays, and hence, to promote the energy efficiency or to reduce the energy consumption is still urgent for human beings.

### SUMMARY OF THE INVENTION

In view of the foregoing, the present invention provides a data center capable of lowering PUE less than 1, and the method thereof.

One purpose of the present invention is to lower PUE of the data center, so as to reduce the usage of the utility power and to further decrease the energy consumption, thereby implementing the effect of energy-saving and carbon-reducing.

Another purpose of the present invention is to provide a data center for achieving PUE less than 1. In other words, the power acquired by the IT device may be greater than the power provided by the utility power source.

To meet aforementioned purposes, the present invention discloses a data center, which comprises: an utility power source for providing utility power; a basic facility electrically connected to the utility power source; a renewable energy source electrically connected to the basic facility for providing renewable energy; an IT device electrically connected to the renewable energy source; wherein power received by the IT device is not less than the utility power provided by the utility power source, whereby making PUE less than 1.

In another aspect, the present invention further discloses a method for providing PUE less than 1, and the steps are described as follows. At first, the utility power can be transmitted to a basic facility by a utility power source, and part of the utility power is consumed by the basic facility. Subsequently, another part of the utility power can be transmitted to an IT device by the basic facility. Then, the renewable energy can be transmitted to the IT device by a renewable energy source; wherein summation of another part of the utility power and the renewable energy both received by the IT device is not less than the utility power provided by the utility power source, whereby making PUE less than 1.

In still another aspect, the present invention further discloses a method for providing PUE less than 1, and the steps are described in the following. First of all, the utility power can be transmitted to a basic facility by a utility power source, and part of the utility power is consumed by the basic facility. Subsequently, another part of the utility power can be transmitted to an IT device by the basic facility. Then, part of renewable energy can be transmitted to the basic facility by a renewable energy source, and another part of the renewable energy can be transmitted to the IT device; wherein the summation of another part of the utility power and another part of the renewable energy both received by the IT device is not less than the utility power provided by the utility power source, whereby making the PUE less than 1.

The data center of the present invention further comprises a renewable energy source electrically connected to the wind power generator and/or the solar energy panel, and the renewable energy can be transmitted into the data center for providing extra power to the IT device, thereby reducing needs of the utility power. As a result, total power received by the IT device may be greater than the utility power provided by the utility power source, whereby making PUE less than 1. Therefore, the usage and cost of the utility power can be reduced effectively if enough renewable energy is provided, so that the effect of energy-saving and carbon-reducing can be achieved.

Aforementioned description is to illustrate purposes of the present invention, technical characteristics to achieve the purposes, the advantages brought from the technical characteristics, and so on. And the present invention can be further understood by the following description of the preferred embodiment accompanying with the claims.

### BRIEF DESCRIPTION OF THE DRAWINGS

FIG. 1 shows the diagram of the traditional data center and the power system;

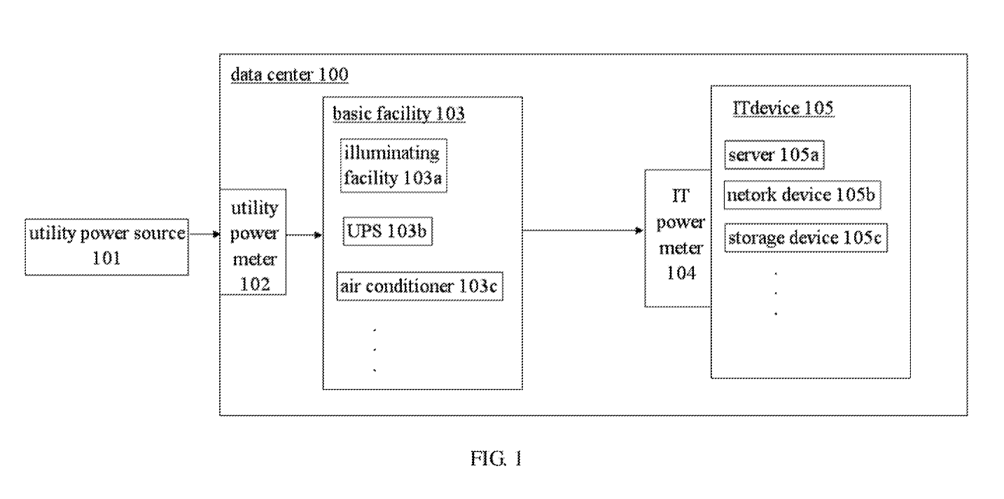

FIG. 2 shows the diagram of the data center of the present invention;

FIG. 3 shows the flow chart of one method of the present invention;

FIG. 4 shows the flow chart of another method of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

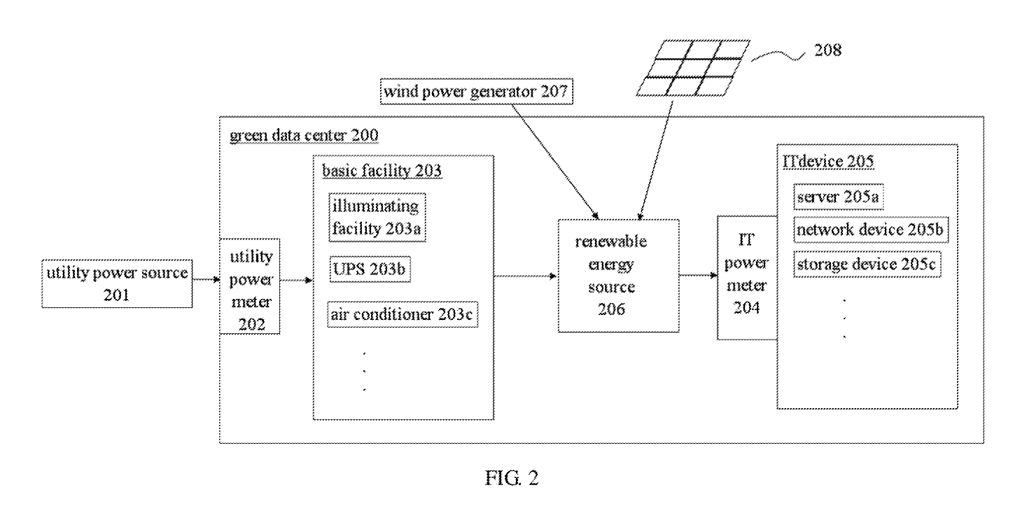

Referred to FIG. 2, which depicts the preferred embodiment of the green data center disclosed by the present invention, the green data center 200 includes a utility power source 201, a utility power meter 202, a basic facility 203, a renewable energy source 206, an IT power meter 204, and an IT device 205. In this embodiment, the facility power source 201, which may be a power supply of the power company, is electrically connected to the basic facility 203 via the utility power meter 202, so as to provide the utility power to the data center 200. Part of the utility power can be consumed by the basic facility 203 for operation. In the embodiment, the basic facility 203 may include an illuminating facility 203a, an UPS 203b, an air conditioner 203c, and so on. Aforementioned equipments are just for explanation, and nevertheless, the basic facility 203 may further include other non-IT devices. Alternatively, the air conditioner 203c or the illuminating facility 203a can be omitted in the basic facility 203, so as to reduce energy consumption and the usage of the utility power, thereby lowering PUE.

The renewable energy source 206 is electrically connected between the basic facility 203 and the IT device 205 for providing power converted from the renewable energy, such as solar energy, wind energy, etc. The renewable energy source 206 of the present invention may be electrically connected to the external wind power generator 207 and/or the solar energy panel 208 for receiving the renewable energy. The IT device 205 may contain a server 205a, a network device 205b, or a storage device 205c, etc, for operating the website. In this embodiment, the power provided by the renewable energy source 206 is mainly transferred to the IT device 205. Therefore, all of the renewable energy can be provided for the IT device 205, or alternatively, part of the renewable energy can be provided for the IT device 205, and another part can be provided for the basic facility 203. Aforementioned two means for transmitting power can be determined by the circuit in the renewable energy source 206, and nevertheless, it is not the main feature of the present invention, so it will not be redundantly described in the following. Additionally, the renewable energy source 206 can also be used to assist transferring the utility power since it is electrically connected between the basic facility 203 and the IT device 205. Hence, except for part of the utility power consumed by the basic facility 203, the residual part of the utility power can be transmitted to the IT device 205 through the renewable energy source 206 for providing power.

In other words, the IT device 205 may receive another part of the utility power and all or part of the renewable energy, rather than just receive the residual utility power as the prior art taught. Therefore, total power received by the IT device 205 of the present invention may be greater than only utility power received by the conventional IT device. When total power received by the IT device 205 is greater than the utility power provided by the utility power source 201, the PUE can be less than 1. It is noted that the renewable energy provided by the renewable energy source 206 has to be higher than the total power received by the basic facility 203 if total power received by the IT device 205 is desired to be higher than the utility power. An embodiment is introduced hereinafter for illustrating the present invention more definitely. Assuming that the utility power provided by the utility power source 201 is “A”, and total power received by the basic facility 203 is “B”, and the renewable energy provided by the renewable energy source 206 is “D”, and the total power received by the IT device 205 is “C.” According to the principle of energy conservation, the inputting energy must be equal to the outputting energy. Therefore, the summation of the utility power A of the utility power source 201 and the power D provided by the renewable energy source 206 equals the summation of the power B consumed by the basic facility 203 and the power C consumed by the IT device 205. Namely, A+D=B+C (equation 1). Further, it has to noted that PUE=A/C. Consequently, it can be inferred that PUE=(B+C−D)/C (equation 2). If PUE less than 1 is desired, the equation “B+C−D<C” must be satisfied, and accordingly, it can be inferred that B<D (equation 3). Based on equation 3, it can be acknowledged that the PUE can be less than 1 if the power B received by the basic facility 203 is not greater than the power D provided by the renewable energy source 206. Furthermore, based on equation 2, it can be acknowledged that when the power D provided by the renewable energy source 206 is greater, the numerator will be lower and closer to 0, and the utility power A will be less. As a result, the utility power provided by the utility power source 201 can be decreased when the renewable energy source 206 provides more power, so as to reduce usage and cost of the utility power.

For example, if the power D provided by the renewable energy source 206 is 35 kW, and the power B consumed by the basic facility 203 is 30 kW, and the power C consumed by the IT device 205 is 50 kW, it can be calculated that the utility power A provided by the utility power source 201 is 45 kW based on equation 1. It can be inferred that PUE=A/C=45/50=0.9<1, thereby implementing the purpose of the present invention. Further, if some basic facilities 203 can be omitted, such as the air conditioner, the consumed power B may be lowered to about 25 kW or not greater than 30 kW. If the power C consumed by the IT device 205 is still 45 kW, and the renewable energy D still remains 35 kW, the utility power A provided by the utility power source 201 can be reduced to 35 kW, and it can be calculated that PUE=A/C=35/45=0.77. Therefore, the PUE can be effectively lowered by reducing the energy consumption of the basic facility 203.

In this embodiment, the data center 200 further comprises a utility power meter 202 electrically connected to the utility power source 201 for measuring the utility power A. Besides, the data center also comprises an IT power meter 204 electrically connected to the IT device 205 for measuring the power C received by the IT device 205.

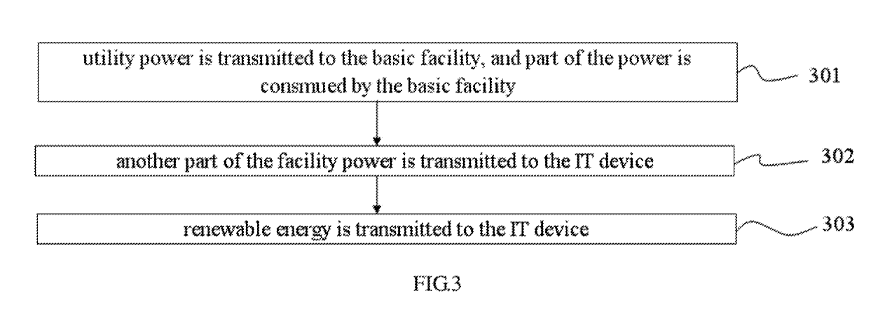

Referred to FIG. 3, the figure illustrates one method for achieving PUE less than 1, and the steps are described as follows. Initially, the utility power can be transmitted to the basic facility by the utility power source 301, and part of the utility power is consumed by the basic facility for operation. Then, residual part of the utility power can be transmitted to an IT device 302. Finally, the renewable energy can be transmitted to the IT device by the renewable energy source for increasing the total power for the IT device 303. In this embodiment, total power received by the IT device must not be less than the utility power provided by the utility power source, namely, the summation of another part of the utility power and the renewable energy both received by the IT device must not be less than the utility power, so that PUE can be less than 1.

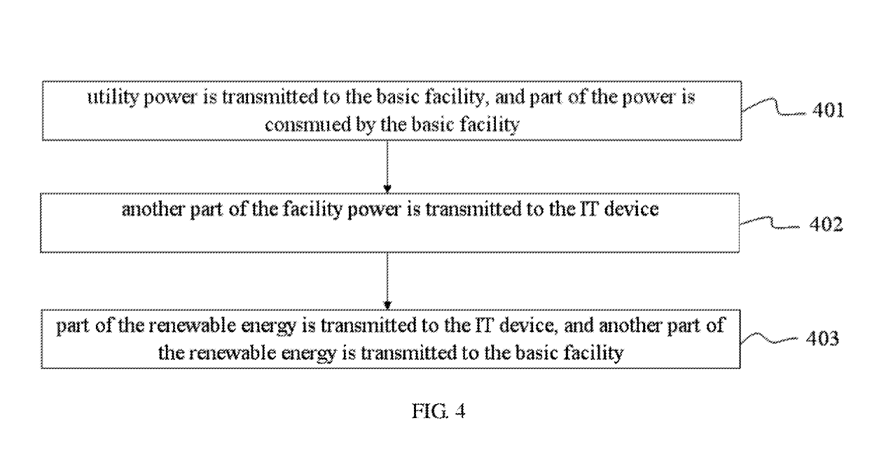

Referred to FIG. 4, the figure illustrates another method for achieving PUE less than 1, and the steps are described in the following. At first, the utility power can be transmitted to the basic facility by the utility power source 401, and part of the utility power is consumed by the basic facility for operation. Then, another part of the utility power can be transmitted to an IT device 402. Finally, part of the renewable energy is transmitted to the basic facility, and another part of the renewable energy is transmitted to the IT device, so as to respectively increase the power of the basic facility and the IT device. The difference between this embodiment and which of FIG. 3 is that the renewable energy source provides no only the IT device but also the basic facility. It has to be noted that total power received by the IT device must not be less than the utility power provided by the utility power source. In other words, the summation of another part of the utility power and another part of the renewable energy both received by the IT device must not be less than the utility power, so as to make PUE less than 1, thereby achieving the purpose of the present invention.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A data center, which comprises:
an utility power source for providing utility power;
a basic facility electrically connected to said utility power source;
a renewable energy source electrically connected to said basic facility for providing renewable energy;
an IT device electrically connected to said renewable energy source;
wherein power received by said IT device is not less than said utility power provided by said utility power source to allow PUE of said data center be less than 1.

2. The data center according to claim 1, wherein power received by said IT device includes part of said utility power and part of said renewable energy.

3. The data center according to claim 1, wherein power received by said IT device includes part of said utility power and all of said renewable energy.

4. The data center according to claim 1, wherein said renewable energy is more than power consumed by said basic facility, so that power received by said IT device is more than said utility power provided by said utility power source.

5. The data center according to claim 1, wherein said PUE equals that said utility power divided by power received by said IT device.

6. The data center according to claim 1, wherein said renewable energy source is coupled to a wind power generator, a solar energy panel, or combinations thereof.

7. The data center according to claim 1, further comprises a utility power meter electrically connected to said utility power source, whereby measuring said utility power.

8. The data center according to claim 1, further comprises an IT power meter electrically connected to said IT device, whereby measuring power received by said IT device.

9. A method for providing PUE less than 1, including steps of:
transmitting utility power by a utility power source to a basic facility to consume part of said utility power by said basic facility;
transmitting residual part of said utility power to an IT device by said basic facility; and
transmitting renewable energy to said IT device by a renewable energy source;
wherein summation of said residual part of said utility power and said renewable energy received by said IT device is not less than said utility power provided by said utility power source to allow said PUE be less than 1.

10. The method according to claim 9, wherein said PUE equals said utility power divided by power received by said IT device.

11. The method according to claim 10, wherein said renewable energy is not less than power consumed by said basic facility, so that said residual part of said utility power and said renewable energy received by said IT device is not less than said utility power provided by said utility power source.

12. The method to claim 10, wherein said renewable energy source is coupled to a wind power generator, a solar energy panel, or combinations thereof.

13. A method for providing PUE less than 1, including steps of:
transmitting utility power to a basic facility by a utility power source to consume part of said utility power by said basic facility;
transmitting residual part of said utility power to a IT device by said basic facility; and
transmitting part of renewable energy to said basic facility by a renewable energy source, and transmitting said residual part of said renewable energy to said IT device;
wherein power received by said IT device is not less than said utility power provided by said utility power source to allow said PUE be less than 1.

14. The method according to claim 13, wherein said PUE equals that said utility power divided by power received by said IT device.

15. The method according to claim 13, wherein said renewable energy is not less than power consumed by said basic facility, so that power received by said IT device is not less than said utility power provided by said utility power source.

16. The method to claim 13, wherein said renewable energy source is coupled to a wind power generator, a solar energy panel, or combinations thereof.
